(19) United States
(12) Patent Application Publication
(10) Pub. No.: US 2016/0016855 A1
(43) Pub. Date: Jan. 21, 2016

(54) FABRICATION OF CARBON NANOTUBE-NONOXIDE STRUCTURAL CERAMIC NANOCOMPOSITES THROUGH LASER SINTERING

(71) Applicants: Benxin WU, West Lafayette, IN (US); Jihua GOU, Orlando, FL (US)

(72) Inventors: Benxin WU, West Lafayette, IN (US); Jihua GOU, Orlando, FL (US)

(21) Appl. No.: 14/738,130

(22) Filed: Jun. 12, 2015

Related U.S. Application Data
(60) Provisional application No. 62/026,905, filed on Jul. 21, 2014.

(51) Int. Cl. C04B 35/56

(52) U.S. Cl. CPC C04B 35/5607

(57) ABSTRACT

Methods for making a carbon nanotube (CNT)-nonoxide structural ceramic nanocomposite as well as for enhancing at least one mechanical property or characteristic of a nonoxide structural ceramic material are provided. A mixture of CNT and nonoxide structural ceramic powder can be laser sintered to form desired carbon nanotube-nonoxide structural ceramic nanocomposites.

### CROSS REFERENCE TO RELATED APPLICATION

This application claims the benefit of U.S. Provisional Patent Application, Ser. No. 62/026,905, filed on 21 Jul. 2014. The co-pending Provisional patent application is hereby incorporated by reference herein in its entirety and is made a part hereof, including but not limited to those portions which specifically appear hereinafter.

### STATEMENT REGARDING FEDERALLY SPONSORED RESEARCH OR DEVELOPMENT

This invention was made with government support under grant/award CMMI 1144949 and CMMI 1144936 both awarded by the National Science Foundation. The government has certain rights in the invention.

### BACKGROUND OF THE INVENTION

1. Field of the Invention

This invention relates generally to laser sintering and, more particularly, to the fabrication of carbon nanotube-nonoxide structural ceramic nanocomposites through laser sintering.

2. Description of Related Art

Ceramics have many important applications, such as surface coatings on mechanical parts to enhance their surface wear and/or corrosion resistance. However, ceramics may often have or experience relatively low fracture toughness, which may limit or negatively affect their applications.

### SUMMARY OF THE INVENTION

One aspect of the subject development relates to a new process of or for the fabrication of carbon nanotube (CNT)-nonoxide structural ceramic nanocomposites through laser sintering of a mixture of CNTs and nonoxide structural ceramic powders (e.g., chromium carbide).

In accordance with one aspect of the subject development a method for making a carbon nanotube (CNT)-nonoxide structural ceramic nanocomposite Involves laser sintering of a mixture of CNT and nonoxide structural ceramic powder to form a carbon nanotube-nonoxide structural ceramic nanocomposite.

In accordance with another aspect of the subject development there is provided a method for enhancing one or more mechanical property or performance of a nonoxide structural ceramic material. In one embodiment, one such method involves mixing a quantity of carbon nanotube (CNT) with the nonoxide structural ceramic to form a mixture. The mixture is subsequently laser sintered to form a carbon nanotube-nonoxide structural ceramic nanocomposite.

Material phase transformations, such as melting and re-solidification, may possibly occur in or during the relevant laser sintering process. Thus, in accordance with at least one aspect of the invention, the term “laser sintering” as used herein in connection with embodiments wherein such melting and re-solidification of the processed material or materials occurs is to be understood as to more broadly generally encompass and include such possible material melting and re-solidification.

The addition of CNTs (that is, the fabrication of CNT-ceramic nanocomposites) can desirably serve to enhance the fracture toughness of ceramics. In accordance with one particular embodiment, the fabrication of CNT-nonoxide structural ceramic nanocomposites is realized through laser sintering, instead of the conventional processes such as hot pressing or plasma spraying, etc.

### BRIEF DESCRIPTION OF THE DRAWINGS

Objects and features of this invention will be better understood from the following description taken in conjunction with the drawing, wherein:

FIG. 1 and FIG. 2 are simplified schematic diagrams showing material processing in accordance with certain preferred aspects of the invention; and

FIGS. 3a-3d are simplified main, end (left side), top and bottom views showing a gas application shield device such as used and shown in FIG. 1, the gas application shield in accordance with one embodiment of the invention.

### DETAILED DESCRIPTION

The invention generally relates to fabrication of carbon nanotube (CNT)-nonoxide structural ceramic nanocomposites through laser sintering of the mixture of CNTs and nonoxide structural ceramic powders (e.g., chromium carbide).

Those skill in the art and guided by the teachings herein provided will understand and appreciate that application of a laser beam as herein provided may serve to realize spatially localized sintering of nanocomposites, and hence can serve to produce ceramic nanocomposites as surface coatings onto a substrate with little thermal damage to the substrate. The production or forming of such surface coatings with little or no thermal damage to the associated substrate is or can be a result that is typically difficult to attain via conventional hot pressing technology.

Under suitable studied processing conditions, the material obtained by laser sintering of chromium carbide powders and the composites obtained by laser sintering of CNT/chromium carbide powder mixtures both have higher hardness values than that of previously reported plasma-sprayed chromium carbide—1 wt. % CNT composites. [See Singh, V., Diaz, R., Balani, K., Agarwal, A., and Seal, S., “Chromium Carbide-CNT Nanocomposites With Enhanced Mechanical Properties”, Acta Materialia, 57 (2009) 335-344.]

In addition, under suitable studied processing conditions, the composites obtained by laser sintering of CNT/chromium carbide powder mixtures have higher fracture toughness, as compared to ceramic materials obtained by laser sintering of chromium carbide powders without CNTs.

Those skilled in the art and guided by the teachings herein provided will understand and appreciate that processing such as herein described may be used to produce CNT-nonoxide structural ceramic nanocomposites with one or more improved or enhanced mechanical property, and that such nanocomposites may have particular attractive application in various uses including, for example, such as in, for, or as surface coatings.

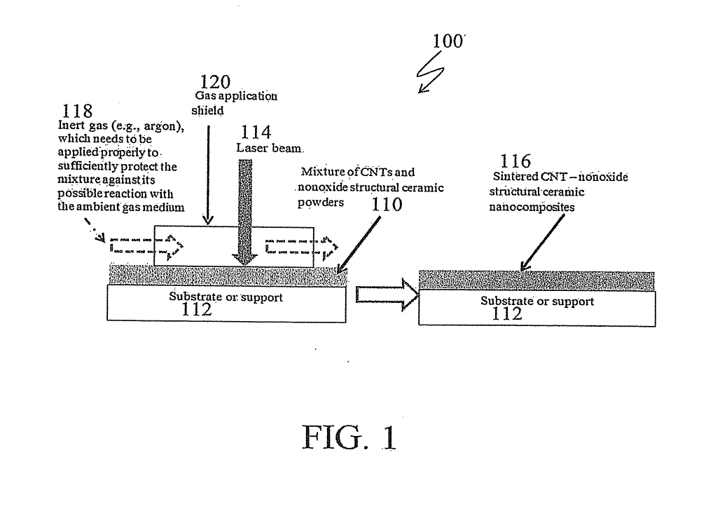

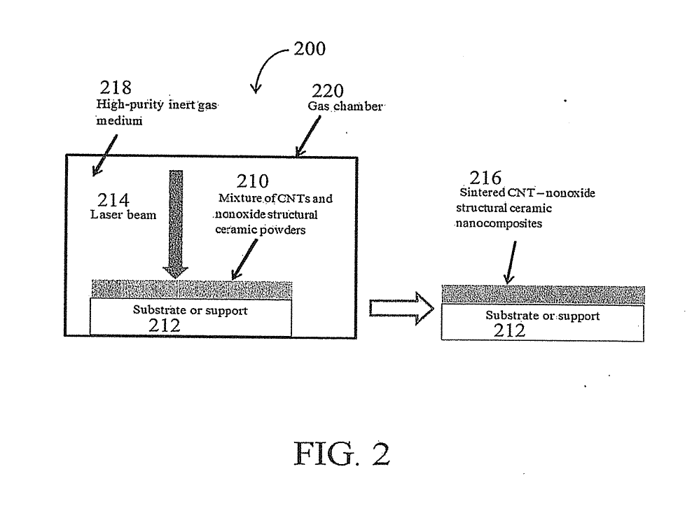

FIGS. 1 and 2 show proposed processing arrangements for the fabrication of CNT-nonoxide structural ceramic nanocomposites through laser sintering in accordance with selected aspects of the invention.

More specifically, FIG. 1 illustrates a processing arrangement, generally designated by the reference numeral 100, wherein a mixture 110 of CNTs and nonoxide structural ceramic powders, such has suitably disposed on a substrate or support surface 112, is appropriately irradiated via a laser beam 114 to form a carbon nanotube-nonoxide structural ceramic nanocomposite 116.

As will be appreciated by those skilled in the art and guided by the teachings herein provided, in the processing of the invention it is typically preferred to process a relatively uniform mixture of CNTs and nonoxide structural ceramic powders. Moreover, the broader practice of the invention is not presently limited by or to any specific or particular method or technique of mixing provided that the selected mixing method or technique provides or produces a relatively uniform mixture of CNTs and nonoxide structural ceramic powders without significantly damaging or physically (or chemically) altering the CNTs or ceramic powders.

An example of a mixing technique applied in accordance with one aspect of the invention involved creating a stable suspension of CNTs in water with an aid of surfactant and sonicating the suspension. A selected nonoxide structural ceramic powder, such as chromium carbide (Cr₃C₂) powder was then added into the suspension, and mixed using high shear mixer and sonication. Finally, through the filtration of the suspension, a desired mixture of CNTs and chromium carbide was produced.

During sintering, it can be critical to properly apply inert atmosphere (such as composed of argon) at or about the mixture 110 being irradiated to sufficiently protect the mixture 110 from possible reactions with the ambient atmosphere or gas medium (such as oxygen present in air). More particularly, it is generally preferred that the inert gas be maintained in a sufficiently high purity in the vicinity of the material being treated such as to avoid, minimize or reduce undesired reactions of the material being treated, for example, such as the possible undesired reaction of oxygen with carbon. In some embodiments it may be desirable to flow an inert gas 118 near, adjacent to or in the vicinity of the material being treated at a sufficient flow rate to avoid, minimize or reduce undesired reactions.

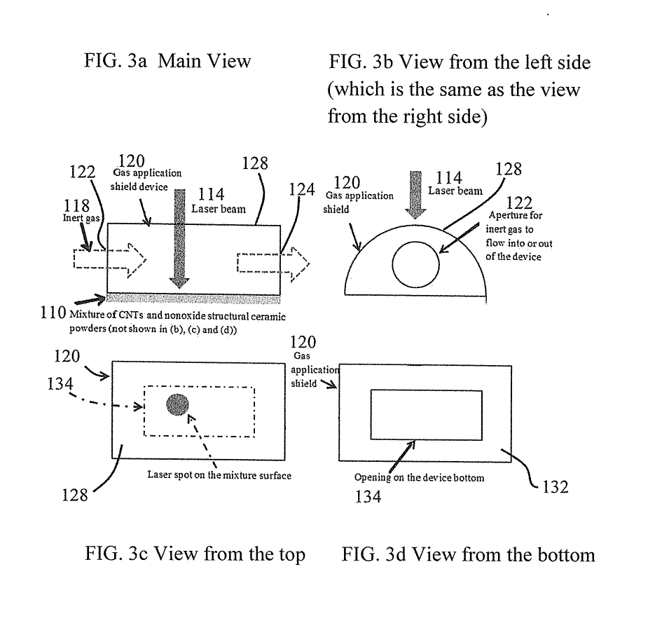

In processing arrangement 100, inert gas protection is realized at least in part via or through a gas application shield device 120, whose detailed structure is more specifically illustrated in FIGS. 3a-3d, where views of the device 120 from multiple directions are shown. The gas application shield device 120 has two primary apertures, a first aperture 122 that primarily serves or acts to allow or permit the inert gas to flow into the device 120 and a second aperture 124 that primarily serves or acts to allow or permit gas outflow from the device 120. In the illustrated embodiment, the device top surface 128 is desirably transparent to permit or allow the laser beam to pass through, while the device bottom 132 has an opening 134 to allow the laser beam 114 to appropriately interact with the CNT-ceramic powder mixture 110 and, in accordance with the invention, sinter the mixture into nanocomposites. Those skilled in the art and guided by the teachings herein provided will understand and appreciate that the invention contemplates and encompasses gas protection devices of various shapes and sizes and that the broader practice of the invention is not necessarily limited to gas protection devices of the illustrated form, shape and size shown in FIGS. 3a-3d. For example, if desired, the device bottom 132 may be entirely open-ended, such as in a form of an inverted cup or the like.

FIG. 2 illustrates a processing arrangement, generally designated by the reference numeral 200, wherein a mixture 210 of CNTs and nonoxide structural ceramic powders such as suitably disposed on a substrate or support surface 212, is appropriately irradiated via a laser beam 214 to form a carbon nanotube-nonoxide structural ceramic nanocomposite 216.

In the processing arrangement 200, inert gas 218 protection is realized at least in part via or through the laser beam 214 irradiation of the mixture 210 within an enclosed environment such as provided via a gas chamber 220.

In the processing arrangement 200 shown in FIG. 2, inert gas protection is realized at least in part via or through the laser beam 214 irradiation of the mixture 210 within an enclosed environment such as provided via a gas chamber 220, more specifically, by placing the mixture 210 and the support or substrate 212 into the chamber 220 such as filled with high-purity inert gas 218. If desired or required, such a chamber can be equipped or provided with a flow and/or filtration system such as to permit periodic or continuous flow and/or filtration of the gas medium therein contained. The chamber may be in a variety of shapes and/or sizes.

Those skilled in the art and guided by the teachings herein provided will understand and appreciate that other processing arrangements may also be possible. In the processing arrangements shown in both FIGS. 1 and 2, nanocomposites are fabricated through laser beam irradiation of a mixture of CNTs and nonoxide structural ceramic powders. Those skilled in the art and guided by the teachings herein provided will further appreciate that the laser spot can move relatively to the mixture surface in certain trajectories to potentially sinter an area that is larger than the laser spot size. If desired or needed, after a layer of the mixture has been sintered into nanocomposites, another layer of the mixture may be placed onto the nanocomposite surface and laser-sintered. In this way, nanocomposites of relatively greater thickness can be potentially produced.

Please note that FIGS. 1 to 3a-d are simple schematic diagrams and they are not drawn to scale, and many details, such as laser optics, are not shown in the figures.

As an example, CNT-chromium carbide nanocomposites may be potentially produced through laser sintering of mixtures of CNTs (˜0.5 wt. %) and Cr₃C₂ (˜99.5 wt. %) powders using a setup similar to FIG. 2, where a laser from SPI at an infrared wavelength is used and laser power is around 120 W (continuous wave), and the relative moving velocity of the laser spot on the mixture surface is around 2 mm/s, and the gas chamber is simply a tube transparent at the laser wavelength (which permits laser beam to enter without being significantly absorbed by the tube wall), where argon flows in from one side and flows out from the other side of the tube.

Those skilled in the art and guided by the teachings herein provided will understand and appreciate that the broader practice of the invention is not necessarily limited to the inclusion of CNTs of any specific type. To that end, while the invention may be practiced employing either or both multi-walled and single walled CNTs, single walled CNTs may be more prone to damage during sinter processing such as to limit the effectiveness of such use. Thus, in accordance with selected embodiments, the use of multi-walled CNTs may be preferred.

Those skilled in the art and guided by the teachings herein provided will also understand and appreciate that the broader practice of the invention is not necessarily limited to the inclusion of CNTs in any specific or particular relative amount. For example, the inclusion of CNTs even in small relative amounts can potentially be desirably beneficial in enhancing one or more mechanical property or characteristic of the resulting material. In accordance with one aspect of the invention the inclusion of at least 0.2 wt. % CNT within the carbon nanotube-nonoxide structural ceramic powder mixture to be sintered may be desirable. In accordance with another aspect of the invention the inclusion of 0.3 to 0.5 wt. % CNT within the carbon nanotube-nonoxide structural ceramic powder mixture to be sintered may be desirable.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention, and any process that utilizes laser beam irradiation of a mixture of CNTs and nonoxide structural ceramic powders to produce CNT-nonoxide structural ceramic nanocomposites is to be regarded as encompassed herein.

For example, while the invention has been described above making specific reference to processing involving or using chromium carbide, those skill in the art and guided by the teaching herein provided will appreciate that the subject processing may be suitably applied or used in conjunction with other nonoxide structural ceramic powder materials that upon laser sintering suitably form a carbon nanotube-nonoxide structural ceramic nanocomposite. Examples of other possible useable nonoxide structural ceramic powder materials may, for example, include one or more of boron carbide (B₄C) and molybdenum carbide (Mo₂C).

Further, while the invention has been described above making specific reference to embodiments utilizing argon as the inert gas, those skilled in the art and guided by the teachings herein provided will understand and appreciate that the broader practice of the invention is not necessarily so limited as, for example, other inert gases such as helium or gases inert under the conditions of operation may potentially be used and are herein included.

Further, while the invention has been described above making specific reference to embodiments wherein the carbon nanotube-nonoxide structural ceramic powder mixture has been placed onto a surface of a support or substrate as shown in FIG. 1. The broader practice of the invention is not necessarily so limited as the invention may, if desired, be practiced without the incorporation or use of such support or substrate elements.

What is claimed is:

1. A method for making a carbon nanotube (CNT)-nonoxide structural ceramic nanocomposite, the method comprising:
laser sintering a mixture of CNT and nonoxide structural ceramic powder to form a carbon nanotube-nonoxide structural ceramic nanocomposite.

2. The method of claim 1 wherein the nonoxide structural ceramic powder comprises at least one of chromium carbide (Cr₃C₂), boron carbide (B₄C) and molybdenum carbide (Mo₂C).

3. The method of claim 2 wherein the nonoxide structural ceramic powder comprises chromium carbide (Cr₃C₂).

4. The method of claim 1 wherein the carbon nanotube-nonoxide structural ceramic powder mixture comprises at least 0.2 wt. % CNT.

5. The method of claim 1 wherein the carbon nanotube-nonoxide structural ceramic powder mixture comprises 0.3 to 0.5 wt. % CNT.

6. The method of claim 1 wherein the mixture is in an inert atmosphere during said laser sintering to avoid reaction of the mixture with the ambient atmosphere.

7. The method of claim 6 wherein during said laser sintering the mixture being sintered is within a chamber containing the inert atmosphere.

8. The method of claim 7 wherein the chamber is equipped with at least one of a flow system and a filtration system to permit at least one of periodic gas medium flow, continuous gas medium flow, periodic gas medium filtration and continuous gas medium filtration to avoid either or both the ambient atmosphere reacting with the mixture and undesirably adsorbing or scattering laser beam energy.

9. The method of claim 7 wherein during said laser sintering the mixture is contained within the chamber.

10. The method of claim 7 wherein the chamber at least in part comprises a gas application shield, said gas application shield permitting the transmission of laser beam energy therethrough without significant alteration.

11. The method of claim 1 wherein the laser sintering a mixture of CNT and nonoxide structural ceramic powder to form a carbon nanotube-nonoxide structural ceramic nanocomposite comprises:
laser sintering a first quantity of a mixture of CNT and nonoxide structural ceramic powder to form a first mass of carbon nanotube-nonoxide structural ceramic nanocomposite and
laser sintering a second quantity of a mixture of CNT and nonoxide structural ceramic powder to form a second mass of carbon nanotube-nonoxide structural ceramic nanocomposite.

12. The method of claim 11 wherein:
the laser sintering of the first quantity of a mixture of CNT and nonoxide structural ceramic powder forms a first layer of carbon nanotube-nonoxide structural ceramic nanocomposite and
the laser sintering of the second quantity of a mixture of CNT and nonoxide structural ceramic powder forms a second layer of carbon nanotube-nonoxide structural ceramic nanocomposite at least in part adjacent the first layer of carbon nanotube-nonoxide structural ceramic nanocomposite.

13. A method for enhancing at least one mechanical property or characteristic of a nonoxide structural ceramic material, the method comprising:
mixing a quantity of carbon nanotube (CNT) with the nonoxide structural ceramic to form a mixture and
laser sintering the mixture to form a carbon nanotube-nonoxide structural ceramic nanocomposite.

14. The method of claim 13 wherein the nonoxide structural ceramic powder comprises at least one of chromium carbide (Cr₃C₂), boron carbide (B₄C) and molybdenum carbide (Mo₂C).

15. The method of claim 14 wherein the nonoxide structural ceramic powder comprises chromium carbide (Cr₃C₂).

16. The method of claim 13 wherein the carbon nanotube-nonoxide structural ceramic powder mixture comprises at least 0.2 wt. % CNT.

17. The method of claim 13 wherein the carbon nanotube-nonoxide structural ceramic powder mixture comprises 0.3 to 0.5 wt. % CNT.

18. The method of claim 13 wherein the carbon nanotube-nonoxide structural ceramic nanocomposite has enhanced fracture toughness as compared to the nonoxide structural ceramic without the carbon nanotube.

19. The method of claim 13 wherein the mixture is in an inert atmosphere during said laser sintering to avoid reaction of the mixture with the ambient atmosphere.

20. The method of claim 19 wherein during said laser sintering the mixture being sintered is within a chamber containing the inert atmosphere.
